(19) United States
(12) Patent Application Publication
(10) Pub. No.: US 2026/0036207 A1
(43) Pub. Date: Feb. 5, 2026

(54) DRY GAS SEAL SYSTEM

(71) Applicant: JOHN CRANE INC., Morton Grove, IL (US)

(72) Inventors: Isaac Lopez, Brentford (GB); Ashvin Varsani, London (GB); Jasper Oranje, Soest (NL); David Pickens, Chicago, IL (US); Brandon Tuttle, Maidenhead (GB); Inderpal Sihra, Maidenhead (GB)

(73) Assignee: JOHN CRANE INC., Morton Grove, IL (US)

(21) Appl. No.: 19/279,478

(22) Filed: Jul. 24, 2025

Related U.S. Application Data
(60) Provisional application No. 63/677,541, filed on Jul. 31, 2024.

(51) Int. Cl. F16J 15/34

(52) U.S. Cl. CPC F16J 15/3496

(57) ABSTRACT

A dry gas seal system for rotating equipment operating on a process fluid. The system includes: a dry gas seal for sealing rotating equipment; an axial end face separation seal comprising a primary ring, a mating ring, a sleeve for coupling the mating ring to the shaft of the rotating equipment, and a retainer for the primary ring; and an oleophobic coating disposed at least partially over each of the following surfaces of the separation seal: at an outer peripheral edge of the primary ring distal to, and facing away from, the shaft of the rotating equipment; at an outer peripheral edge of the mating ring distal to, and facing away from, the shaft of the rotating equipment; and both surfaces of the mating ring and primary ring which interface with each other.

### CROSS-REFERENCE TO RELATED APPLICATION

This application claims the benefit of priority under 35 U.S.C. § 119(e) to U.S. Provisional Patent Application Ser. No. 63/677,541, filed Jul. 31, 2024. The entire content of this application is hereby incorporated by reference herein.

### TECHNICAL FIELD

The present invention relates to a dry gas seal system for rotating equipment operating on a process fluid, said seal system comprising an axial end face separation seal and an oleophobic coating disposed at least partially over surfaces of the separation seal. The present invention also relates to a process for providing a seal gas for a seal configured for use with a seal gas and used for sealing rotating equipment operating on a process fluid, said process comprising the use of a liquid ejector.

### BACKGROUND

Rotating equipment intended for operation on a process fluid typically include axial, centrifugal, and rotary screw compressors and expanders for use in oil refineries, as well as petrochemical facilities, gas plants, liquefied natural gas (LNG) facilities and oil and gas production facilities. A common application for seal systems is in connection with centrifugal compressors which are typically used at intervals along a natural gas pipeline to boost the gas pressure for processing, to counter the effect of flow losses along the transmission pipelines and to facilitate movement of the gas towards its destination. These compressors can be used upstream (during exploration and production), midstream (during processing, storage and transportation), or downstream (during natural gas/and petrochemical refining, transmission and distribution) in a petrochemical process.

To move natural gas or other fluids, centrifugal compressors use a rotating disk or impeller contained in a housing to increase the pressure of a process gas. The rotation of the disk/impeller is provided by a rotating shaft that is driven by an external motor or turbine. The shaft can be mated to the rotor of the compressor that carries the disk/impeller. Non-contacting seals which rely on a gas lubrication may be used in connection with rotating equipment, a common example of which being the dry gas seal. Dry gas seals surround the rotor at or near where the rotor enters housing to form a seal that prevents the process gas from escaping at that location.

In general, dry gas seals operate by providing a seal between a rotating ring and a stationary ring. The rotating ring is sometimes referred to as a “mating ring” as it is mated to the rotating shaft/rotor. The rotating ring can be mated to the rotor via a shaft sleeve. The stationary ring, also known as the “primary ring”, does not rotate during operation.

In operation, a layer of gas is developed between the two rings that forms a seal while allowing the rings to move relative to one another without contacting each other. The gas layer may be formed from seal gas injected into the dry gas seal. Grooves in the rotating (mating) ring draw the process gas from an outer radial edge of the mating ring to a location in between the two rings. The gas that is drawn into the grooves is compressed as it moves toward the radially inward ends (or tips) of the grooves. The compressed gas creates a pressure dam that causes the primary ring to “lift off’ from the mating ring to form a running gap that is in the range of few microns (e.g., 3-10 μm). To allow for relative axial movement between the rings, the primary ring is typically mounted to a stationary portion of the dry gas seal by a compressible member such as a spring or other implement. After liftoff, a very small amount of gas flows over the dam area to the low pressure side of the seal (e.g., outside of the compressor), creating a controlled seal leakage, and the rings operate on the thin film of gas as a non-contacting seal.

Dry gas seals may be used to reduce frictional wear on the rotating components while preventing leakage of the centrifuged or processed gas. To further inhibit leakage of processed gas into the atmosphere, some centrifugal compressors can include a pair of dry gas seals working in tandem. One example of such a mechanical seal system is described in U.S. Pat. No. 8,651,801, and another example is described in U.S. Pat. No. 10,871,167, the contents of which are incorporated by reference.

Regardless of the type of dry gas seal configuration (e.g. double or tandem), a dry gas seal system typically includes a separation seal (also known as a “barrier seal”) which functions to prevent process fluid from entering the bearing housing in the event of a seal failure, and also to prevent lubricating oil from entering the seal cartridge. The separation seal is typically provided in the form of a labyrinth design, contacting carbon rings, bushing carbon rings, or an axial end face. The separation seal in a dry gas seal system is supplied with a separation gas (typically an inert gas such as nitrogen) that is injected between two separation seal elements, providing a barrier between the atmospheric bearing housing and the dry gas seal. If a labyrinth, it is injected between the two sections of teeth of the labyrinth, if a carbon ring type seal then between a pair of carbon rings, or between sealing elements of an axial end face separation seal. Axial end face separation seals, which include a lift-off design, consume the least amount of separation gas and there is little change in gas consumption from static to dynamic conditions.

As the separation seal is positioned on the bearing side, it is most at risk of coming into contact with lubricating oil and therefore the reliability of the separation seal can affect the maintenance lifetime of the dry gas seal system. During pressurized conditions (both static and dynamic) the lubricating oil of the bearing is kept outside the sealing gap. However, during any unpressurized stages of operation, oil in the vicinity can migrate into the sealing gap as a result of capillary effects.

To limit the ingress of oil, mechanical aids can be used, in the form of flingers or secondary seals such as labyrinths. These will delay the ingress of oil but eventually oil will migrate into the cavity. These mechanical aids also have disadvantages, such as trapping the oil once it has reached the cavity, making it difficult to expel due to centrifugal forces. There remains a need for the provision of a separation seal for a dry gas seal system which is capable of resisting capillary effects, particularly during unpressurized stages of operation, to prevent oil ingress into the seal gap.

### SUMMARY OF INVENTION

In one aspect, there is provided a dry gas seal system for rotating equipment operating on a process fluid, wherein the system comprises:
i) a dry gas seal for sealing rotating equipment;
ii) an axial end face separation seal comprising a primary ring, a mating ring, a sleeve for coupling the mating ring to the shaft of the rotating equipment, and a retainer for the primary ring; and
iii) an oleophobic coating disposed at least partially over each of the following surfaces of the separation seal:
   a) at an outer peripheral edge of the primary ring distal to, and facing away from, the shaft of the rotating equipment;
   b) at an outer peripheral edge of the mating ring distal to, and facing away from, the shaft of the rotating equipment; and
   c) both surfaces of the mating ring and primary ring which interface with each other.

In another aspect, there is provided an axial end face separation seal for a dry gas seal system for rotating equipment operating on a process fluid, the separation seal comprising a primary ring, a mating ring, a sleeve for coupling the mating ring to the shaft of the rotating equipment during operation, and a retainer for the primary ring; wherein the separation seal includes an oleophobic coating disposed at least partially over each of the following surfaces of the separation seal:
a) at an outer peripheral edge of the primary ring distal to, and facing away from, the shaft of the rotating equipment during operation;
b) at an outer peripheral edge of the mating ring distal to, and facing away from, the shaft of the rotating equipment during operation;
c) both surfaces of the mating ring and primary ring which interface with each other during operation.

In yet another aspect, there is provided a method of operating a dry gas seal system for rotating equipment operating on a process fluid, wherein the method comprises:
i) providing a dry gas seal system as described herein installed on the shaft of rotating equipment for operating on a process fluid; and
ii) providing a stream of separation gas to the separation seal of the dry gas seal system installed on the rotating equipment.

In still another aspect, there is provided a method for providing a coated axial end face separation seal for a dry gas seal system for rotating equipment operating on a process fluid, said method comprising:
i) providing a primary ring, a mating ring, a sleeve for coupling the mating ring to the shaft of the rotating equipment during operation, and a retainer for the primary ring;
ii) providing an oleophobic coating at least partially over each of the following surfaces of the separation seal:
   a) at an outer peripheral edge of the primary ring distal to, and facing away from, the shaft of the rotating equipment during operation;
   b) at an outer peripheral edge of the mating ring distal to, and facing away from, the shaft of the rotating equipment during operation;
   c) both surfaces of the mating ring and primary ring which interface with each other during operation; and
iii) assembling the primary ring, mating ring, sleeve, and retainer to form the coated separation seal.

### BRIEF DESCRIPTION OF THE DRAWINGS

The disclosure can be more completely understood in consideration of the following detailed description by reference to the accompanying drawing, in which:

FIG. 1 is a schematic drawing of an axial end face seal as described herein.

### DETAILED DESCRIPTION

Oleophobic coatings are known in a variety of industries for their repellency and ability to modify the contact angle of surfaces upon which they are applied. However, the use of oleophobic coatings has hitherto not been known in the context of separation seals for dry gas seals. The present inventors have found that coating particular surfaces of the separation seal prevents ingress of oil into the seal gap, for instance, during periods of depressurization in the seal chamber. The presence of the oleophobic coating effectively prevents possible ingress of oil into the seal gap from the bearing and protects the seal chamber during times of depressurization. By decreasing the surface energy of certain separation seal surfaces/increasing the contact angle of oil at these surfaces, the inventors have found it possible to reduce capillary pressure, thereby preventing unwanted oil ingress and/or migration. In particular, by modifying surfaces of the seal to maintain any oil that may come in contact in the shape of a droplet, the oil is prevented from expanding into the sealing gap. This additional functionality is particularly useful for extending the life-cycle of the separation seal, and the dry gas seal system containing it.

It has been found by the inventors that the location of the oleophobic coating on the surfaces of the separation seal as described herein is advantageous for its performance in preventing the ingress of oil that may lead to seal failure.

Thus, in one aspect, there is provided a dry gas seal system for rotating equipment operating on a process fluid, wherein the system comprises:
i) a dry gas seal for sealing rotating equipment;
ii) an axial end face separation seal comprising a primary ring, a mating ring, a sleeve for coupling the mating ring to the shaft of the rotating equipment, and a retainer for the primary ring; and
iii) an oleophobic coating disposed at least partially over each of the following surfaces of the separation seal:
   a) at an outer peripheral edge of the primary ring distal to, and facing away from, the shaft of the rotating equipment;
   b) at an outer peripheral edge of the mating ring distal to, and facing away from, the shaft of the rotating equipment; and
   c) both surfaces of the mating ring and primary ring which interface with each other.

The separation seal of the present disclosure is an axial end face seal upon which the oleophobic coating is provided. Whilst labyrinths have lower capital cost, they are known to consume the most seal gas during operation. Thus, when the cost of seal gas consumption is accounted for, the axial end face seal provides a lower life-cycle cost. This is complemented by improvements to reliability provided by the oleophobic coating described herein which confers resistance to oil ingress and migration that may otherwise lead to seal failure.

The greater the contact angle of a liquid on a surface the less likely that the liquid will spread out over the surface, i.e. the less likely the surface will become wetted with the liquid. The contact angle of the liquid is determined by the surface energy of the solid compared to the surface energy of the liquid. If the liquid has a higher surface energy than the solid, the liquid will bead up and resist spreading over the solid surface.

The contact angle (θ) is an angle formed at the three-phase boundary where a solid, liquid and gas intersect and is an inverse measure of wettability. Thus, the higher the contact angle (θ) the poorer the wettability. In accordance with Young's equation below, by lowering the surface energy of a solid (SG), it is possible to increase the contact angle (θ) of the liquid and lower the likelihood of spread of the liquid/wetting of the solid surface.

γ^{SG}=γ^{SL}+γ^{LG} cosθ

(θ is the contact angle; SG is the solid surface free energy; SL is the solid/liquid interfacial energy; LG is the liquid surface free energy).

Any oleophobic coating may be used which is capable of lowering the surface energy of the solid separation seal surfaces and which increases the contact angle with an oil in comparison to the uncoated solid surface. The contact angle may be measured by depositing a drop of oil on a flat surface of the material and measuring the angle made by the tangent of the drop with the material. Preferably, the contact angle is measured using a contact angle goniometer.

Suitable oleophobic coatings may comprise fluorinated silanes, fluorinated polyhedral oligomeric silsesquioxanes (F-POSS); bisphosphonic compounds bearing a partially fluorinated, perfluorinated (PF) or perfluoropolyether (PFPE) group; self-assembled monolayer of phosphonates (SAMPs); or combinations thereof.

Fluorinated silanes such as perfluoropolyether silanes are, for instance, described in U.S. Pat. No. 7,294,731 B1, and US 2006/0014895, the contents of which are incorporated by reference. Specific examples of fluorinated silanes include 1H,1H,2H,2H-Pefluorodecyltrichlorosilane, 1H,1 H,2H,2H-Pefluorooctyltrichlorosilane, 1H,1H,2H,2H-Pefluorodecyltriethoxysilane, and 1H,1H,2H,2H-Pefluoroalkylltriethoxysilane. U.S. Pat. No. 9,725,619 B2 describes an oleophobic coating composition comprising a fluorinated silane compound comprising a polyvalent transition metal component, as well as the reaction product of a silicone and a perfluorohydrocarbyl polyether compound.

F-POSS compounds are, for instance, described in J M Mabry et al., “Fluorinated polyhedral oligomeric silsesquioxanes (F-POSS)”, Angew Chem Int Ed Engl. 2008;47(22):4137-40. These compounds may be prepared through a facile single-step, base-catalyzed condensation of trialkoxy silanes. The fluorodecyl POSS (FD-POSS) compounds are a preferred subset of F-POSS compounds for their increased oleophobicity.

Bisphonic compounds bearing a partially fluorinated, perfluorinated (PF) or perfluoropolyether (PFPE) group are, for instance, described in WO 2017/144480 A1, the content of which is incorporated by reference. Examples include bisphonic compounds comprising a linear or branched, saturated or unsaturated, linear or branched C₁-C₁₀₀ alkyl chain, which is perfluorinated or partially fluorinated, and which may be substituted or interrupted by 1 to 10 aryl groups which may or may not be perfluorinated. Other examples include or bisphonic compounds comprising a group —(CH₂)ₘ—X in which m is an integer between 1 and 100 and X is a saturated or unsaturated C₁-C₁₀₀ alkyl group, which is perfluorinated or partially fluorinated, wherein the alkyl group may be substituted or interrupted by 1 to 10 aryl groups which can be perfluorinated or not. In preferred embodiments, the bisphonic compounds comprise a perfluorinated or partially fluorinated C₉-C₂₀ alkyl group.

Self-assembled monolayer of phosphonates (SAMPs) generally include a fluorinated hydrocarbylpolyether group with a phosphonate or phosphonic acid end group. SAMP monolayers may have a single molecule thickness, or a of thickness approximately 1-4 nanometers. U.S. Pat. No. 8,025,974 B2, the content of which is incorporated by reference, describes SAMPs for imparting oil repellent properties to surfaces by directly adhering SAMPs to inorganic substrates or indirectly adhering them through an intermediate organometallic coating. U.S. Pat. No. 7,396,594 B2, the content of which is incorporated by reference, describes the formation of self-assembled monolayer of phosphonates (SAMPs) by contacting an oxide surface with a coating composition comprising a phosphorus acid. U.S. Pat. No. 8,236,426 B2, the content of which is incorporated by reference, describes applying SAMPs to inorganic substrates including metals, such as stainless steel, as well as metalloids such as silicon, a metal alloys and ceramic substrates. SAMPs are also available for coating organometallics and epoxy substrates.

SAMPs containing coatings have been formulated for numerous markets including optical, display, electronics, and industrial coatings. They exhibit particularly desirable properties including adhesion, stain resistance, and scratch resistance. SAMP coatings incorporate covalent bonding to the surface and thereby offer mechanical and chemical stability over a wide range of conditions, including those to which separation seal surfaces are commonly exposed. Thus, in preferred embodiments, the oleophobic coating described herein comprises SAMPs.

Application of the oleophobic coating to the surfaces of the separation seal may be achieved by applying the coating compound in a suitable liquid carrier (e.g. dissolved in a solvent or suspended in the liquid carrier) to the surface and drying to form the adhered coating. For example, the liquid carrier may be an aqueous solvent and/or a, preferably volatile, alcohol-based solvent (e.g. a methanol or ethanol based solution comprising methanol or ethanol). Depending on the extent of the volatility of the liquid carrier, then evaporation can be effective to deposit and adhere the oleophobic coating. Alternatively, active drying may be undertaken my subjecting the surface to a stream of gas (e.g. air) or by gentle heating.

Application of the oleophobic coating may be achieved by wiping the separation seal surfaces with a carrier (e.g. cloth or wipe) impregnated with the coating solution before being dried. Alternatively, the oleophobic coating may be applied by spray-coating, knife coating, spin coating, dip coating, roll coating. Dip-coating is generally preferred since it allows more certainty that a surface has been adequately contacted with the coating solution. Alternatively, vapor deposition techniques may be utilised depending on compatibility of the oleophobic coating component.

Where application of the coating is achieved by wiping then the carrier may be porous or non-porous, and may be of woven or non-woven construction. Preferred carriers include cellulose materials, for example, cotton fiber, which may include chemical surface modification to optimise the hydrophilic nature of the surface depending on the particular coating solution. Depending on the particular coating and substrate compositions, an intermediate layer or layers may be provided on the separation seal surface to enable or enhance adhesion of the oleophobic coating.

Prior to application of the coating, it is preferable to ensure that the relevant seal surface is adequately clean and free from contamination particulate (e.g. dust). Cleaning techniques depend on the type of substrate and include, for example, a solvent washing step with a volatile organic solvent, such as acetone or ethanol. Alternatively, surfaces may be cleaned by corona surface treatment or plasma surface treatment, which are particularly effective at removing particulate contamination at the substrate surface that can otherwise disrupt adhesion.

As described herein, the oleophobic coating is disposed at least partially over, preferably disposed substantially over the entirety of, each of the following surfaces of the separation seal: a) at an outer peripheral edge of the primary ring distal to, and facing away from, the shaft of the rotating equipment; b) at an outer peripheral edge of the mating ring distal to, and facing away from, the shaft of the rotating equipment; and c) both surfaces of the mating ring and primary ring which interface with each other. As will be appreciated, the type and thickness of the coating on each surface can be the same or different. Preferably, the same oleophobic coating is used for each of the above surfaces.

The coating, including any intermediate layers for adhering to the substrate surface, may be provided over a variety of thicknesses, such as from 1 nanometer and 500 micrometers, depending on the composition and the extent of intermediate layers that may be present for adhering to the substrate. Coating of the separation seal as described herein has not been found to materially impact any of the functionality (e.g. “lift off” performance) of the separation seal.

Coating of the surfaces of the separation seal described above is capable of preventing flow of oil that may enter the seal chamber (for instance, as a result of ingress from the bearing side) thereby delaying or substantially avoiding seal failure as a result of oil ingress. The separation seal is therefore able to resist seal failure mechanisms associated with oil ingress, improving the seal's reliability and extending its life cycle in providing a barrier for the dry gas seal from the bearing.

Thus, in another aspect, there is provided a method of operating a dry gas seal system for rotating equipment operating on a process fluid, wherein the method comprises:
i) providing a dry gas seal system as described herein installed on the shaft of rotating equipment for operating on a process fluid; and
ii) providing a stream of separation gas to the separation seal of the dry gas seal system installed on the rotating equipment.

In some embodiments, the method of operating the dry gas seal system includes periods of separation gas depressurisation during operation and/or start-up.

In addition to the surfaces of the separation seal described above, it has found by the inventors to also be preferable to coat other surfaces of the separation seal with the oleophobic coating as described herein to enhance the beneficial effects. For example, in embodiments wherein the sleeve includes a shroud which at least partially overhangs the outer peripheral edge of the mating ring, then it has been found to be advantageous to also coat a surface at an outer region of the shroud, distal to the shaft of the rotating equipment. For instance, the oleophobic coating may be provided on i) an outer peripheral edge of the overhanging portion of the shroud which faces away from the shaft of the rotating equipment, and/or ii) a surface of the overhanging portion of the shroud which faces in the axial direction towards the primary ring.

In another example, the retainer of the axial end face seal may be additionally coated with an oleophobic coating as described herein at an outer region distal to the rotating shaft. For instance, when the retainer includes a portion which at least partially overhangs the outer peripheral edge of the primary ring to at least partially enclose the primary ring, an oleophobic coating as described herein may be at least partially disposed on an inner surface of the overhanging portion of the retainer which faces in a radial direction towards the primary ring and/or faces in an axial direction towards the mating ring.

Rotating equipment typically includes a motor-driven shaft that drives a rotatable component, such as an impeller for compression/pumping of a gas/liquid. The rotating equipment to which the seal system of the present disclosure may be applied is not particularly limited and includes all axial, centrifugal, rotary screw, and reciprocating compressors and expanders, as well as centrifugal pumps for operation on certain process liquids, including in supercritical applications. Particularly preferred rotating equipment for use with the present seal system are centrifugal compressors and expanders, most preferably centrifugal compressors. The process fluid on which the rotating equipment operates is not particularly limited and includes all industrial gases, liquids or supercritical fluids that may require pumping, compression or expansion. Examples include hydrocarbon-based gases, such as natural gas, as well as hydrocarbon liquids, including liquid natural gas (LNG).

Preferred examples of dry gas seals for use in the dry gas seal system of the disclosure include double seals (e.g. in back-to-back arrangement), and tandem-type dry gas seals with an intermediate labyrinth. For instance, in the case of tandem type dry gas seals, seal gas flows across the primary seal (inboard stage) of the dry gas seal out towards the primary vent, and across the inboard process labyrinth, back into the process. The seal gas can be differential-pressure controlled to ensure the seal gas is at higher pressure than the primary seal vent. In a double-type dry gas seal, seal gas is injected between the primary and secondary seals at a higher pressure than the product pressure. One part of the seal gas leakage escapes to the atmosphere side and the other part to the product side. In some embodiments, the dry gas seal conforms to American Petroleum Institute (API) 692 or API 614.

The dry gas seal system disclosed herein includes a separation seal upon which an oleophobic coating is disposed. The separation seal is provided in the form of an axial end face seal. As the skilled person appreciates, axial end face seals are characterised by a lift off design comprising a primary ring, which remains stationary during operation of the rotating equipment, a mating ring which is configured for rotation with the shaft of the rotating equipment. A sleeve is provided for securing the mating ring to the rotating shaft and a retainer is provided for securing the primary ring in its stationary position relative to the seal chamber.

A mating ring suitable for use in the axial end face seal described herein may, for instance, be formed from cast iron, stainless steel, Ni-resist, titanium alloys, ceramic (Al₂O₃), silicon nitride, silicon carbide, tungsten carbide, and graphite composites. Preferably, the mating ring is formed from silicon carbide. The primary ring for use in the axial end face separation seal described herein may, for instance, be formed of carbon graphite, ceramic (Al₂O₃), stainless steel, tungsten carbide and silicon carbide. Preferably, the primary ring is formed from carbon graphite. The skilled person is readily able to provide an oleophobic coating on the surfaces of the mating and primary rings regardless of their composition and is able to select a suitable method of application of the coating accordingly, for instance, using any necessary intermediary layers to facilitate adhesion to the surface.

In an another aspect, there is provided an axial end face separation seal for a dry gas seal system for rotating equipment operating on a process fluid, the separation seal comprising a primary ring, a mating ring, a sleeve for coupling the mating ring to the shaft of the rotating equipment during operation, and a retainer for the primary ring; wherein the separation seal includes an oleophobic coating disposed at least partially over each of the following surfaces of the separation seal: a) at an outer peripheral edge of the primary ring distal to, and facing away from, the shaft of the rotating equipment during operation; b) at an outer peripheral edge of the mating ring distal to, and facing away from, the shaft of the rotating equipment during operation; and c) both surfaces of the mating ring and primary ring which interface with each other during operation.

In another aspect, there is provided a method for providing a coated axial end face separation seal for a dry gas seal system for rotating equipment operating on a process fluid, said method comprising:
i) providing a primary ring, a mating ring, a sleeve for coupling the mating ring to the shaft of the rotating equipment during operation, and a retainer for the primary ring;
ii) providing an oleophobic coating at least partially over each of the following surfaces of the separation seal:
   a) at an outer peripheral edge of the primary ring distal to, and facing away from, the shaft of the rotating equipment during operation;
   b) at an outer peripheral edge of the mating ring distal to, and facing away from, the shaft of the rotating equipment during operation;
   c) both surfaces of the mating ring and primary ring which interface with each other during operation; and
iii) assembling the primary ring, mating ring, sleeve, and retainer to form the coated separation seal. In some embodiments, the method may also include the additional step of integrating the coated separation seal into a dry gas seal system adjacent a bearing cavity in order to operate on rotating equipment as described herein.

As will be appreciated, embodiments described above in connection with the dry gas seal system comprising the axial end face separation seal may also apply to the above recited aspects directed to operation of the dry gas seal system, to the separation seal itself, and to the method of providing a coated axial end face separation seal. For instance, the oleophobic coating may be as described hereinbefore, as well as the composition and configuration of the separation seal components.

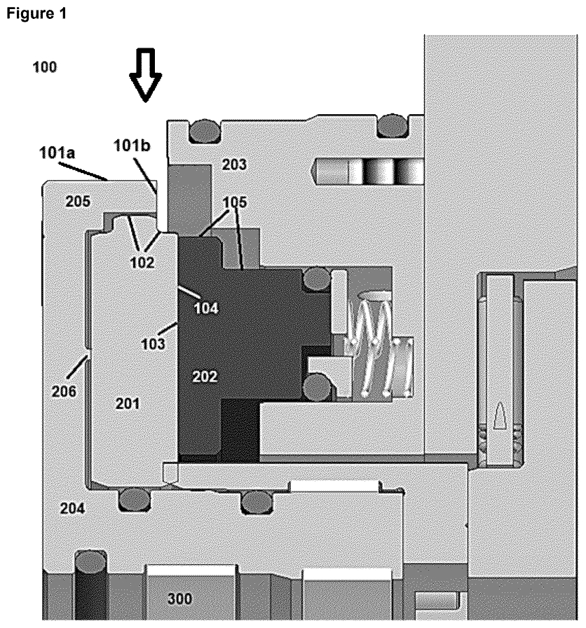

The system, axial end face seal and methods of the present disclosure will now be further described with reference to FIG. 1 which shows a schematic representation of an axial end face seal 100 as described herein. The separation seal 100 includes a mating ring 201 which is secured to the shaft 300 of the rotating equipment by means of sleeve 204 and abutment 206. The sleeve 204 may include a shroud portion 205 which overhangs the outer peripheral edge 102 of the mating ring 201, distal to the shaft 300, as shown in FIG. 1. As illustrated, the shroud 205 overhangs the outer peripheral edge 102 of the mating ring 201. When the sleeve 204 includes a shroud portion 205, an oleophobic coating may be provided at least partially on the outer region (e.g. the outer peripheral edge 101a and/or outer surface 101b which faces in the axial direction towards the primary ring 202 and retainer 203) of the shroud 205. In this arrangement, the outer region of the shroud 205, which is distal to shaft 300, occupies a position within the seal chamber which is closer to the seal housing (not shown) compared to the mating 201 and primary 202 rings and is therefore more likely to be initially contacted with any oil that has leaked to the seal chamber. The most likely direction of oil ingress is shown by the arrow in FIG. 1.

Thus, it is preferable for an oleophobic coating to also be provided on an outer region of the shroud 205 surface. For example, an oleophobic coating may be disposed on the outer peripheral edge 101a of the overhanging portion of the shroud which faces away from the shaft 300 of the rotating equipment as shown. Alternatively or additionally, the oleophobic coating may be disposed on a surface 101b of the overhanging portion of the shroud 205 which faces in the axial direction towards the primary ring 202 and retainer 203 as shown.

In alternative arrangements, the sleeve 204 may not include a shroud portion 205 and the sleeve 204 may instead extend radially adjacent the mating ring 201 only partially beyond abutment 206. In all configurations, the sleeve 204 is attached to the rotating shaft 300 such that it rotates with the rotating shaft 300, the abutment 206 fixably coupling the mating ring 201 and sleeve 204. The illustrated sleeve 204 is shown as a unitary piece but could include any number of pieces that are either joined together or otherwise held stationary relative to each other during operation (e.g., all pieces rotate together as one).

Mating ring 201 and primary ring 202 have interfacing surfaces 103 and 104, respectively. It is between surfaces 103 and 104 that a separation gas follows a fluidic path which provides gas lubrication between the seal rings and enables the “lift off” design associated with axial end face seals. The axial end face seal 100 includes retainer 203 which secures the stationary primary ring 202. The outer peripheral edge 105 of the primary ring, distal to the shaft 300, faces an overhanging portion of the retainer 203 in the arrangement shown in FIG. 1, although alternative configurations may be implemented.

An oleophobic coating may also be provided on a surface at an outer region of the retainer 203, distal to the rotating shaft 300. As with the shroud 205 discussed above, the proximity of the outer region of the retainer 203 to the seal housing (not shown) makes it additionally advantageous to have oil repellency in this area, since the most likely direction of oil ingress (in the direction shown with the arrow in FIG. 1) means that the retainer 203 may be contacted before the mating 201 and primary 202 rings. It has been found that, in certain configurations, coating a surface of the retainer which faces towards the outer peripheral edge 105 of the primary ring 202 is particularly effective at repelling oil flow towards the sealing rings.

Thus, in configurations as, for example, shown in FIG. 1 wherein the retainer 203 includes a portion which at least partially overhangs the outer peripheral edge 105 of the primary ring 202 to at least partially enclose the primary ring 202, an oleophobic coating may be at least partially disposed on an inner surface of the overhanging portion of the retainer 203 which faces in a radial direction towards the primary ring 202 (i.e. toward peripheral edge 105) and/or faces in an axial direction towards the mating ring 201.

An oleophobic coating, preferably comprising SAMPs as described herein, is provided at least partially over the surface of the outer peripheral edge 102 of the mating ring 201, the outer peripheral edge 105 of the primary ring 202, the interfacing surface 103 of the mating ring 201 and the interfacing surface 104 of the primary ring 202. Coating of these surfaces has been found to be advantageous in preventing flow of oil that has leaked into the chamber and delaying or substantially avoiding seal failure as a result of oil ingress. The separation seal 100 which includes the oleophobic coating has increased resistance to potential seal failure mechanisms resulting from oil ingress increasing its reliability and extending its life cycle in providing a barrier for the dry gas seal from the bearing.

It should be understood that the individual steps used in the methods of the present teachings may be performed in any order and/or simultaneously, as long as the teaching remains operable. Furthermore, it should be understood that the system and methods of the present teachings can include any number, or all, of the described embodiments, as long as the teaching remains operable.

Various embodiments of systems and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A dry gas seal system for rotating equipment operating on a process fluid, wherein the system comprises:
i) a dry gas seal for sealing rotating equipment;
ii) an axial end face separation seal comprising a primary ring, a mating ring, a sleeve for coupling the mating ring to the shaft of the rotating equipment, and a retainer for the primary ring; and
iii) an oleophobic coating disposed at least partially over each of the following surfaces of the separation seal:
a) at an outer peripheral edge of the primary ring distal to, and facing away from, the shaft of the rotating equipment;
b) at an outer peripheral edge of the mating ring distal to, and facing away from, the shaft of the rotating equipment; and
c) both surfaces of the mating ring and primary ring which interface with each other.

2. A system according to claim 1, wherein the sleeve includes a shroud which at least partially overhangs the outer peripheral edge of the mating ring, and wherein an outer region of the shroud, distal to the shaft of the rotating equipment, includes an oleophobic disposed on its surface.

3. A system according to claim 2, wherein the surface of the shroud on which the oleophobic coating is disposed is: i) an outer peripheral edge of the overhanging portion of the shroud which faces away from the shaft of the rotating equipment, and/or ii) a surface of the overhanging portion of the shroud which faces in the axial direction towards the primary ring.

4. A system according to claim 1, wherein the retainer includes an oleophobic coating disposed on its surface at an outer region distal to the rotating shaft.

5. A system according to claim 4, wherein the retainer includes a portion which at least partially overhangs the outer peripheral edge of the primary ring to at least partially enclose the primary ring, and wherein the oleophobic coating is at least partially disposed on an inner surface of the overhanging portion of the retainer which faces in a radial direction towards the primary ring and/or faces in an axial direction towards the mating ring.

6. A system according to claim 1, wherein the oleophobic coating comprises fluorinated polyhedral oligomeric silsesquioxanes (POSS); bisphosphonic compounds bearing a partially fluorinated, perfluorinated (PF) or perfluoropolyether (PFPE) group; self-assembled monolayer of phosphonates (SAMPs); or combinations thereof.

7. A system according to claim 6, wherein the oleophobic coating comprises self-assembled monolayer of phosphonates (SAMPs).

8. A system according to claim 1, wherein the dry gas seal comprises a double seal with inboard and outboard seals in back-to-back arrangement, or wherein the dry gas seal comprises a tandem seal arrangement with an intermediate labyrinth.

9. A system according to claim 1, wherein the dry gas seal system conforms to American Petroleum Institute (API) 692 or API 614.

10. A system according to claim 1, wherein the rotating equipment is a centrifugal compressor, axial compressor, rotary screw compressor, or reciprocating compressor.

11. An axial end face separation seal for a dry gas seal system for rotating equipment operating on a process fluid, the separation seal comprising a primary ring, a mating ring, a sleeve for coupling the mating ring to the shaft of the rotating equipment during operation, and a retainer for the primary ring; wherein the separation seal includes an oleophobic coating disposed at least partially over each of the following surfaces of the separation seal:
a) at an outer peripheral edge of the primary ring distal to, and facing away from, the shaft of the rotating equipment during operation;
b) at an outer peripheral edge of the mating ring distal to, and facing away from, the shaft of the rotating equipment during operation;
c) both surfaces of the mating ring and primary ring which interface with each other during operation.

12. A separation seal according to claim 11, wherein the sleeve includes a shroud which at least partially overhangs the outer peripheral edge of the mating ring, and wherein an outer region of the shroud, distal to the shaft of the rotating equipment, includes an oleophobic disposed on its surface.

13. A separation seal according to claim 11, wherein the surface of the shroud on which the oleophobic coating is disposed is: i) an outer peripheral edge of the overhanging portion of the shroud which faces away from the shaft of the rotating equipment during operation, and/or ii) a surface of the overhanging portion of the shroud which faces in the axial direction towards the retainer during operation.

14. A separation seal according to claim 11, wherein the retainer includes an oleophobic coating disposed on its surface at an outer region distal to the rotating shaft during operation.

15. A separation seal according to claim 14, wherein the retainer includes a portion which at least partially overhangs the outer peripheral edge of the primary ring to at least partially enclose the primary ring, and wherein the oleophobic coating is at least partially disposed on an inner surface of the overhanging portion of the retainer which faces in a radial direction towards the primary ring and/or faces in an axial direction towards the mating ring.

16. A separation seal according to claim 11, wherein the oleophobic coating comprises fluorinated polyhedral oligomeric silsesquioxanes (F-POSS); bisphosphonic compounds bearing a partially fluorinated, perfluorinated (PF) or perfluoropolyether (PFPE) group; self-assembled monolayer of phosphonates (SAMPs); or combinations thereof.

17. A separation seal according to claim 16, wherein the oleophobic coating comprises self-assembled monolayer of phosphonates (SAMPs).

18. A method of operating a dry gas seal system for rotating equipment operating on a process fluid, wherein the method comprises:
i) providing a dry gas seal system according to claim 1 installed on the shaft of rotating equipment for operating on a process fluid;
ii) providing a stream of separation gas to the separation seal of the dry gas seal system installed on the rotating equipment.

19. A method according to claim 18, wherein the separation seal of the dry gas seal system undergoes periods of separation gas depressurisation during operation and/or start-up.

20. A method for providing a coated axial end face separation seal for a dry gas seal system for rotating equipment operating on a process fluid, said method comprising:
i) providing a primary ring, a mating ring, a sleeve for coupling the mating ring to the shaft of the rotating equipment during operation, and a retainer for the primary ring;
ii) providing an oleophobic coating at least partially over each of the following surfaces of the separation seal:
a) at an outer peripheral edge of the primary ring distal to, and facing away from, the shaft of the rotating equipment during operation;
b) at an outer peripheral edge of the mating ring distal to, and facing away from, the shaft of the rotating equipment during operation;
c) both surfaces of the mating ring and primary ring which interface with each other during operation; and
iii) assembling the primary ring, mating ring, sleeve, and retainer to form the coated separation seal.
